(19) United States
(12) Patent Application Publication
(10) Pub. No.: US 2023/0382023 A1
(43) Pub. Date: Nov. 30, 2023

(54) Expanded Foam Product Molding Process and Molded Products Using Same

(71) Applicant: Brock USA, LLC, Boulder, CO (US)

(72) Inventors: Stephen Keyser, Boulder, CO (US); John Shaffer, Boulder, CO (US)

(73) Assignee: Brock USA, LLC, Boulder, CO (US)

(21) Appl. No.: 18/031,252

(22) PCT Filed: Oct. 12, 2021
(86) PCT No.: PCT/US2021/054609

§ 371 Date: Apr. 11, 2023

Related U.S. Application Data
(60) Provisional application No. 63/090,506, filed on Oct. 12, 2020.

(51) Int. Cl. B29C 44/34; B29C 44/44

(52) U.S. Cl. CPC B29C 44/343; B29C 44/445; B29K 2023/00

(57) ABSTRACT

A steam chest mold includes two mold sections defining a mold cavity and a plurality of steam tubes having steam ports positioned within the mold cavity. The mold cavity is closable to contain and compress a plurality of beads such as expanded polyolefin beads. The steam tubes pass through the beads such that steam is injected through the steam ports into the beads to facilitate localized melting and bonding o the bead interfaces to produce a water-impervious panel or billet form. The steam tubes permit bonding of interior beads in thick section billets and panels that cannot be accessed by perimeter steam sources.

### CROSS-REFERENCE TO RELATED APPLICATIONS

This application claims the benefit of U.S. Provisional Application No. 63/090,506, filed Oct. 12, 2020, the disclosure of which is incorporated herein by reference in its entirety.

### BACKGROUND OF THE INVENTION

This application relates in general to a method and apparatus for molding expanded polyolefin beads into thick-section blocks and more particularly to a method and apparatus to ensure through-thickness curing and formation of through-thickness features in thick-section polyolefin blocks.

Steam chest molding is a process in which beads of thermoplastic foam are fused together in a mold cavity between two mold halves. Beads of foam are pneumatically injected into the mold cavity as it is closed. A small gap or “crack” in the mold closure is maintained during filling. When the fill step is completed, steam is injected into the steam chest that surrounds the mold and permeates the mold cavity through steam vents in the mold surface. Vacuum is pulled on one side of the mold while steam is injected into the other side. As the steam is applied the mold is completely closed and the beads in the mold cavity are tightly compressed. The heat energy contained in the steam causing the beads to expand, soften, and their surfaces fuse together, forming a fluid impermeable foam structure. The steam and vacuum pathways are then reversed through the mold. The side that first introduced steam now pulls a vacuum, while the original vacuum side injects steam to ensure that all of the beads expand and fuse together. The steam and vacuum are then shut off and the steam chest is flooded with cold water to cool the mold and foam surface before the mold is opened and the part is ejected.

Conventional steam chest molding techniques do not provide a way to mold a thick block or billet of an expanded polyolefin, expanded polypropylene (EPP), expanded polyethylene (EPE) foam. In current EPP billet molding processes, as shown in FIGS. 1A-1E, the product geometry is limited to approximately six inches of thickness. This thickness limitation results from the inability to achieve sufficient steam penetration to the interior of the part such that the bead surfaces completely fuse together without overheating and causing the surface beads in the part to collapse. As shown in FIG. 1A, two mold sections 10 and 12 are closed together to form a billet cavity 14. Though not shown, one mold half may include rods that fit into mating holes of the other mold half. The rods are solid rods that form finished drainage holes through the panel thickness. Solid rods have a generally smooth outer surface which facilitates separation of the mold halves and ejection of the part from the cavity. FIG. 1B shows closed cell foam bead material 16 is blown into the cavity 14. FIG. 1C illustrates the application of steam to the mold. The steam diffuses rapidly into the part through vent holes in the mold. The thermal energy of the steam causes the foam beads to expand and fuse together. As shown in FIG. 1D, water is sprayed into the mold to cool the mold cavity and formed part. The water is then removed by vacuum. In FIG. 1E, the mold halves are separated and the product is ejected.

The steam chest molding process is used to form large blocks (length×width) of EPP foam (“planks”) having thickness sections up to about 6 inches that are sold to secondary processors or packaging providers who cut or carve the planks into smaller parts. Many of these products are used as packaging for commercial goods being shipped to consumers or other companies. One process used to cut or carve the planks is a hot wire or abrasive wire slicing process to make panels, similar to slicing a loaf of bread. In addition to the fabrication of packaging foam, EPP plank can be used to form finished products. The hot wire process can be computer controlled to form specific surface structures, such as one surface having ridges and the other surface being flat. These panels form the basic structure of a shock pad panel for artificial turf systems. In certain applications, the panels are installed with the ridges on the top to provide lateral water drainage. Since the planks from which the panels are sliced are 100% fused bead with no air spaces between beads, vertical drainage can only be achieved by a secondary step of punching or melting holes in the panels. Thus, it would be desirable to provide the ability to form thick section EPP or EPE components, improve processing times for thinner foam bead products such as artificial turf shock pads, and eliminate the post-processing step of forming the through holes through the cut panel sections.

### SUMMARY OF THE INVENTION

This invention relates to a molding process for forming expanded foam bead products and a mold design to effect such a process. In particular, this invention relates to a steam chest mold capable of forming very thick billets of EPP and/or EPE, the ability to improve the processing time for forming thinner billets or finished EPP/EPE products. Steam pipes in fluid contact with the steam chest protrude into the mold cavity and not only provide a pathway for steam to fuse the beads in the interior of the part, but also provide a pathway for moisture to quickly diffuse from the interior of the part. The added pathway reduces reliance on a hot air oven to facilitate moisture removal and stabilization of part geometry. The resultant holes in the billet form drainage holes when the billet is sliced into thin panels to form a shock pad for installation under artificial turf.

### CLAIMS

The expanded polypropylene (EPP) molding process typically involves a molding machine that accommodates a molding die configured as two halves forming a cavity with the front and back surfaces of a plank or billet when closed. As shown in the processing sequence illustrations of FIGS. 1A-1E, the mold halves are brought together and beads of polyolefin material, such as polyethylene or polypropylene, are blown or otherwise injected into the mold cavity. Steam is applied to the mold and rapidly diffuses into the cavity and the part through vent holes in the mold. The thermal energy of the steam causes the foam beads to expand and soften. As the beads expand within the closed cavity, their contacting surfaces fuse together with adjacent beads, forming a solid, non-porous structure, such as the EPP planks. Water is sprayed into the mold for cooling the mold cavity and part. In one embodiment, the water may be removed by a vacuum process. The part is ejected from the mold cavity as the mold halves are separated.

EPP planks are nominally W 48″×L 72″×T 6″, though other sizes can be made which are larger or smaller. The length (L) and width (W) dimensions are limited by the size of the mold, and therefore by the size of the molding machine. The thickness (T) is limited by the ability to force steam into the interior portions of the part and cause the beads to fully fuse together. The steam loses energy as it diffuses through the part, so that if the part is too thick the interior beads may not fuse correctly while the beads near the surface may over-expand and collapse. After the plank is removed from the mold, it usually has residual stresses in the foam that cause distortion in the part geometry. The plank must be annealed in an oven to help the part return to its molded shape and remove water from the part.

Because of the slow diffusion of steam to effectively reach beads within the center of the mold cavity, one embodiment of the invention provides conduit tubes or piping having a steam vent area that passes through the mold cavity within the plank thickness to provide thermal and fluidic communication of steam to the EPP beads within the cavity. The conduit piping is also capable of forming passages through the thickness of the EPP planks. Where the planks are the starting stock for formation of shock pad structures, the invention solves the problem of adding drainage holes in the plank molding process while also providing a means of allowing steam to easily reach the interior of the plank. The holes also reduce the time to anneal the part after molding and provide a pathway for moisture to diffuse out of the interior of the part.

Various aspects of this invention will become apparent to those skilled in the art from the following detailed description of the preferred embodiment, when read in light of the accompanying drawings.

### BRIEF DESCRIPTION OF THE DRAWINGS

FIGS. 1A-1E are a schematic illustrations of the prior art steps of molding an EPP plank.

FIG. 2 is a perspective view of a first half of a mold form showing a first mold face pattern and plurality of steam forming and curing tubes extending from the mold cavity inner face in accordance with an embodiment of the invention.

FIG. 3A is a perspective view of a second half of a mold cavity showing a second mold face pattern and a plurality of ejector pins extending from the second half cavity inner face in accordance with the FIG. 3A embodiment of the invention.

FIG. 3B is an enlarged view of an ejector pin of the second mold half of FIG. 3A.

FIG. 4A is a perspective view of a first mold portion of a thick-section billet mold form, configured as a mold lid, in accordance with another embodiment of the invention.

FIG. 4B is a plan view of a second mold portion of a thick-section billet mold form, configured as a mold cavity, in accordance with the FIG. 4A embodiment of the invention.

FIG. 4C is an enlarged view of the mold cavity of FIG. 4B showing a plurality of steam forming and curing tubes in a deployed or extended position and ejector pins in a retracted position.

FIG. 4D is an enlarged view of the mold cavity of FIG. 4B showing the plurality of steam forming and curing tubes in a retracted position and the ejector pins in a deployed or extended position.

FIG. 4E is a perspective view of an exterior portion of the mold cavity of FIG. 4B showing the retracted ejector pins extending from the mold housing and control valves of the steam forming and curing tubes. verify with Steve

FIG. 5A is a schematic illustration of first and second mold halves in an open position and having steam forming and curing tubes extending through the part cavity.

FIG. 5B is a schematic illustration of first and second mold halves in a closed position and having steam forming and curing tubes extending from the first mold section, through the part cavity, and into ports in the second mold section in accordance with another embodiment of the invention.

FIG. 5C is an enlarged schematic illustration of a portion of the first and second mold halves and the forming and curing steam tubes of FIGS. 5A and 5B.

FIG. 6 is an enlarged, schematic illustration of a mold cavity, similar to that formed by the mold halves shown in FIG. 2, 3 or 4A, B to produce a molded plank or billet.

FIG. 7 is an enlarged, schematic illustration of another embodiment of a mold cavity having panel curtains extending within the mold cavity to form panel cavities.

FIG. 8A is a schematic illustration of first and second mold sections being closed and forming the mold cavity of FIG. 7 with the panel curtains extending through the cavity and polymer bead injection ports.

FIG. 8B is a schematic illustration of first and second mold sections forming the mold cavity of FIG. 8A in an open position.

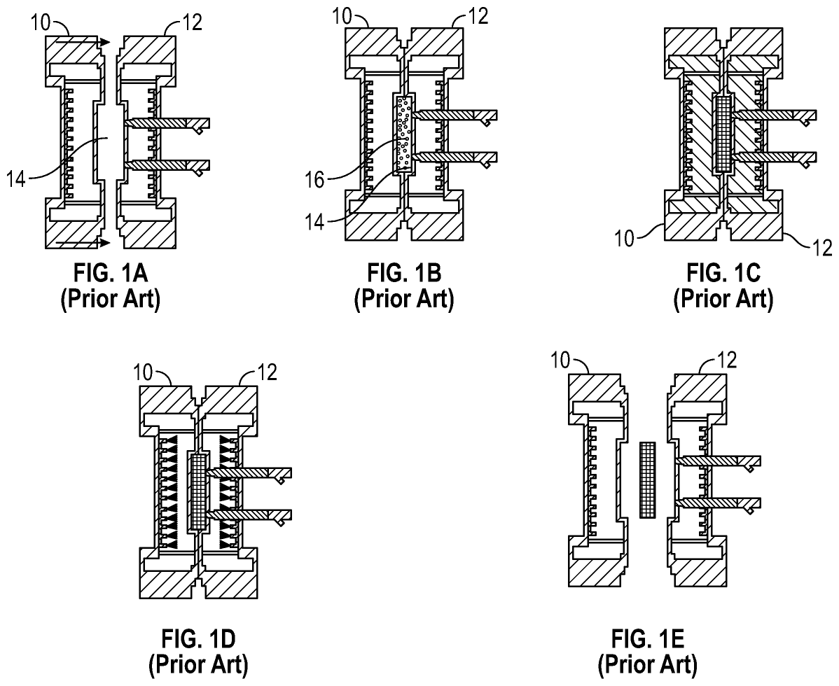

### DETAILED DESCRIPTION OF THE PREFERRED EMBODIMENT

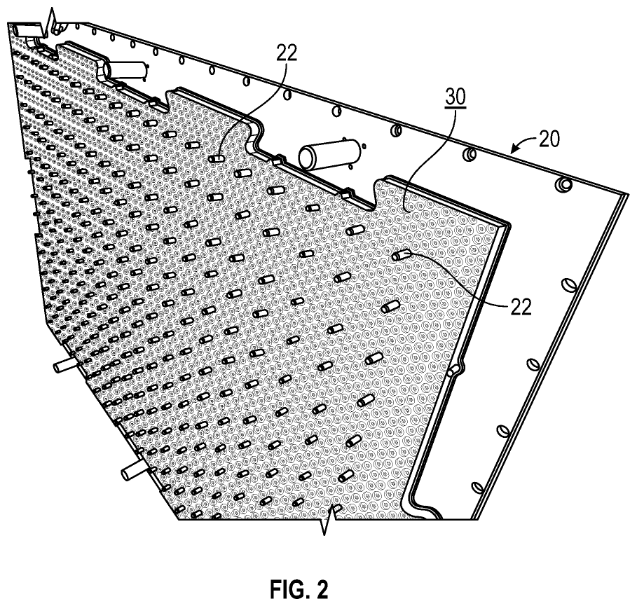

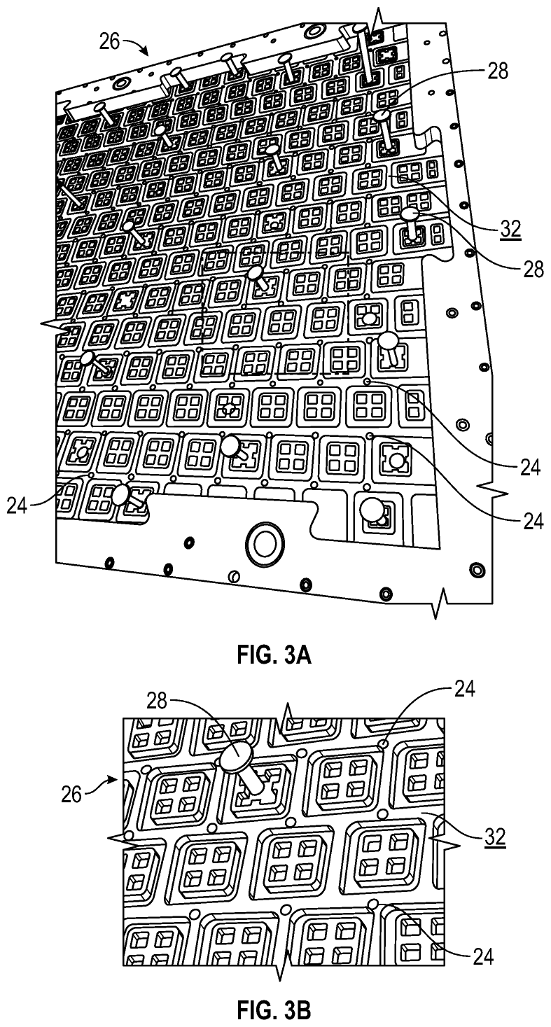

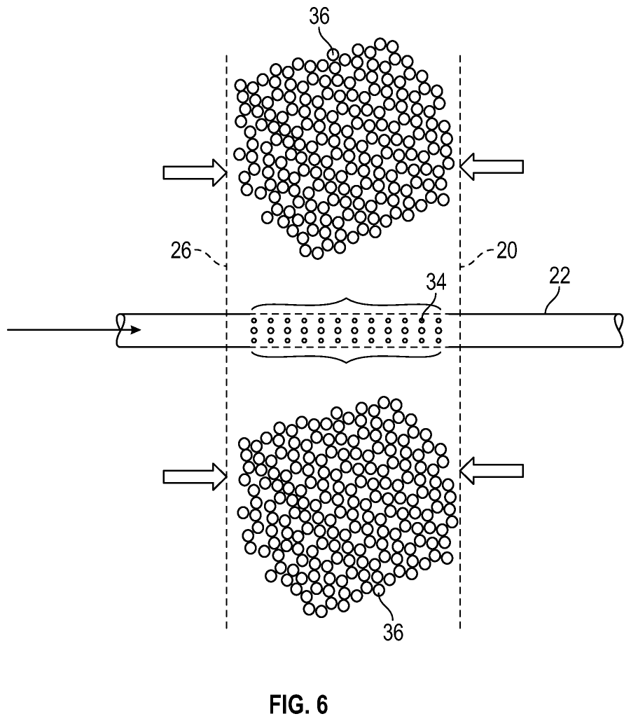

Referring now to the drawings, there are illustrated in FIGS. 2A and 2B two halves of a steam chest mold. A male or first side, shown generally at 20, of a single panel mold (FIG. 2) includes steam tubes 22 that are configured to extend through a cavity formed when the two mold halves are brought together. In the illustrated embodiment, the steam tubes 22 fit into and/or seal against mating holes 24 of a female or second side 26 of the mold (FIG. 3A). The first and second panels 20 and 26 represent front and back sides of a formed artificial turf shock pad. As shown in FIGS. 3A and 3B, ejector pins 28 extend from the female mold surface to push the finished part away from the mold half. Alternatively, the ejector pins 28 and the steam tubes 22 may be located on the same side of the panel, either first panel 20 or second panel 26. The male and female mold halves 20 and 26, respectively, have desired surface topographies 30 and 32 formed on the inner surfaces. As can be seen in the illustrated embodiment, the outer profile of the male mold panel 20 is configured to fit within the mating profile of the female panel 26. As shown in FIG. 6, the steam tubes 22 include a plurality of steam exit ports 34 which may be configured as holes; arc-segment, circumferential slits; longitudinal slots; or any suitable exit geometry to permit steam to leave the tube and enter compressed beads 36 deposited between the mold halves.

As an example of one aspect of the invention, a thin panel may have spacing between holes 24 formed by steam tubes 22 in a range of about 1.75 inches to about 3.0 inches and a hole diameter of about 0.25 inches. As the panel thickness increases, the hole diameter and relative spacing may also increase as a function of the associated steam tube configurations which define the holes. In one example, the hole spacing may be in a range of about 2.50 inches to about 3.75 inches with a hole diameter of about 0.38 inches. In another embodiment, the spacing between holes may be in a range of about 2.75 inches to about 5.0 inches and a diameter of about 0.5 inches. In still another embodiment, the spacing between holes may be in a range of about 4.0 inches up to about 8.0 inches and a diameter of about 0.75 inches as the panel thickness transitions from “thin” to “thick”. The hole spacing and the associated steam tube spacing is related to panel thickness, bead volume and density. In one embodiment related to a panel having a finish-molded density of about 0.0011 lb./cu. in. (30 gm/L) to about 0.0025 lb./cu. in. (70 gm/L), a range of relative hole spacing is bounded by a maximum preferred spacing equal to the general thickness of the panel up to about 6 inches. In this embodiment, greater panel thicknesses may adequately utilize about a 6 inch hole spacing with consistent bead-bonding results. While not an absolute association, other consideration such as changes in final panel density may increase or decrease the spacing limits. In another embodiment, the range may be from about 3 inches to about 4 inches between hole centerlines and have a hole diameter in a range of about 0.4 inches to about 0.8 inches. The hole spacing may also be determined in relation to the panel thickness such that lateral/longitudinal spacing between holes is approximately equal to the panel thickness.

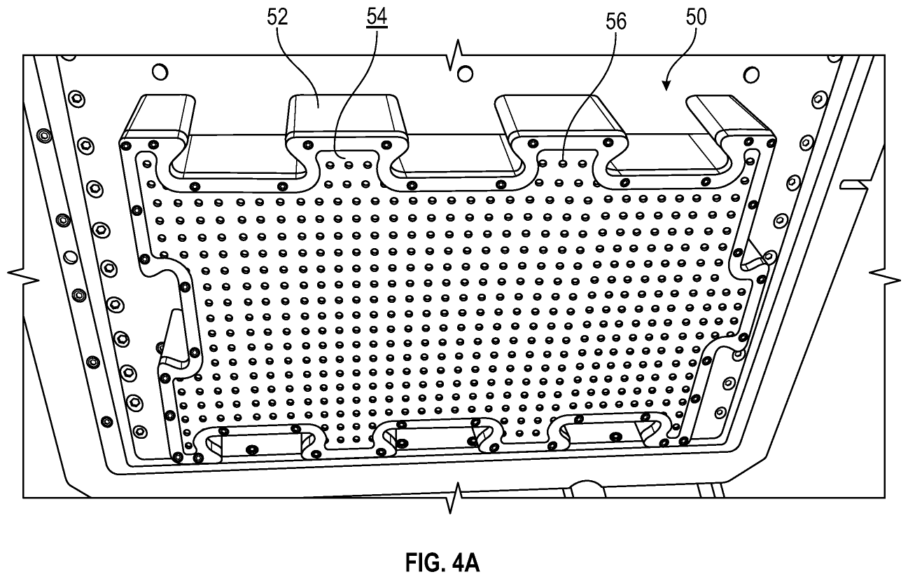

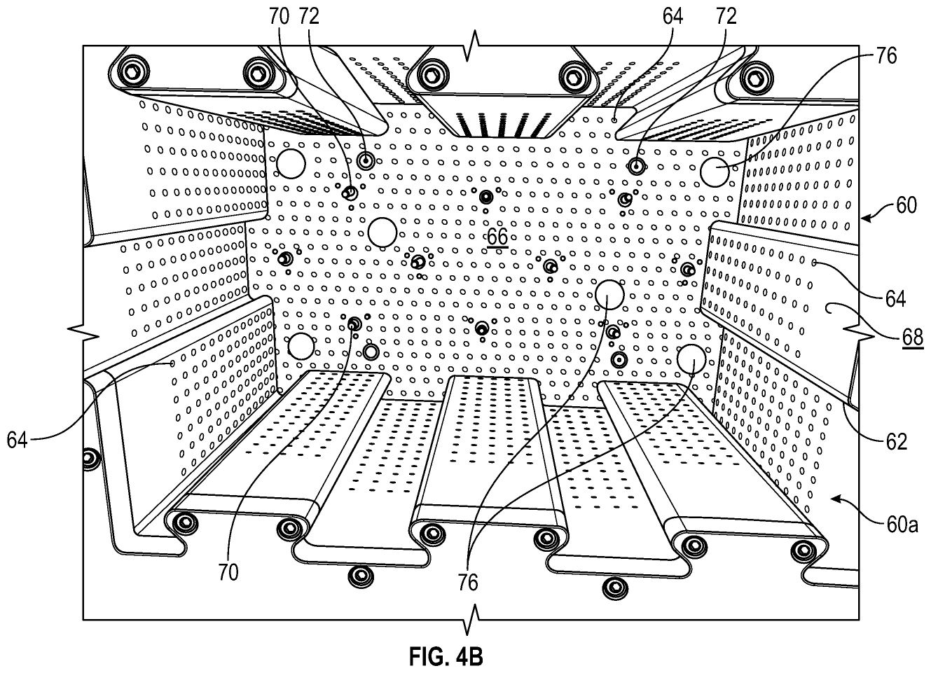

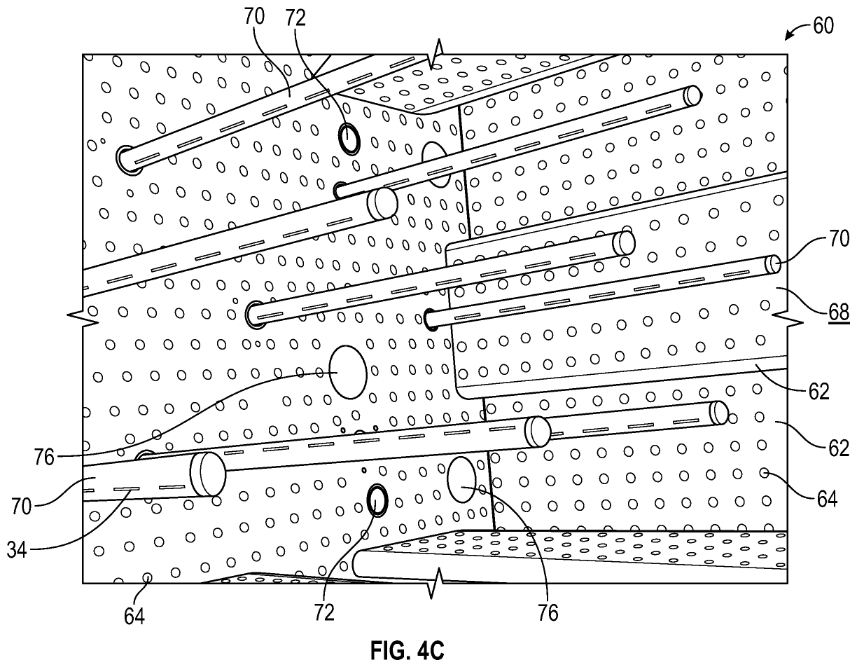

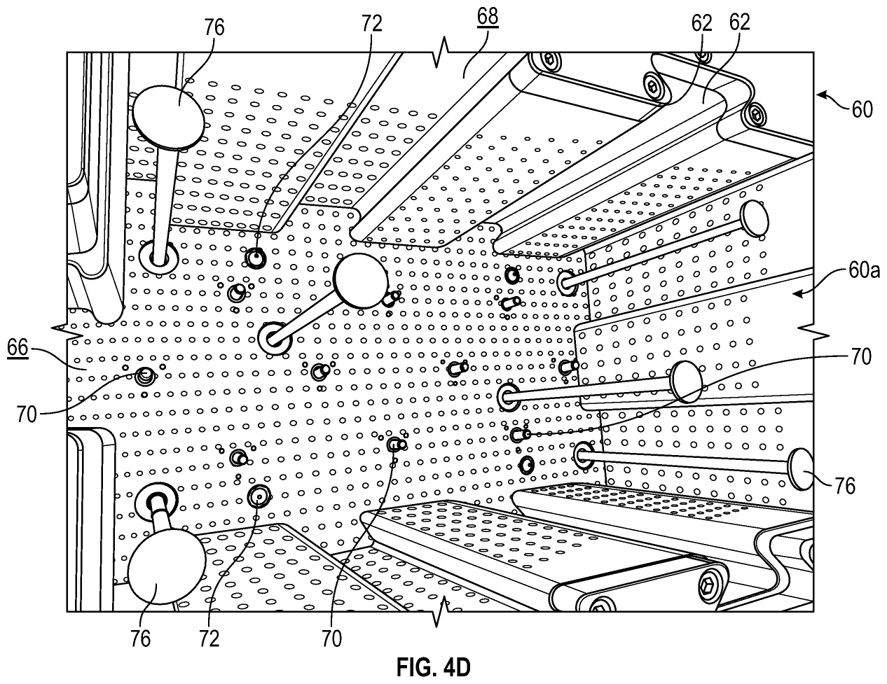

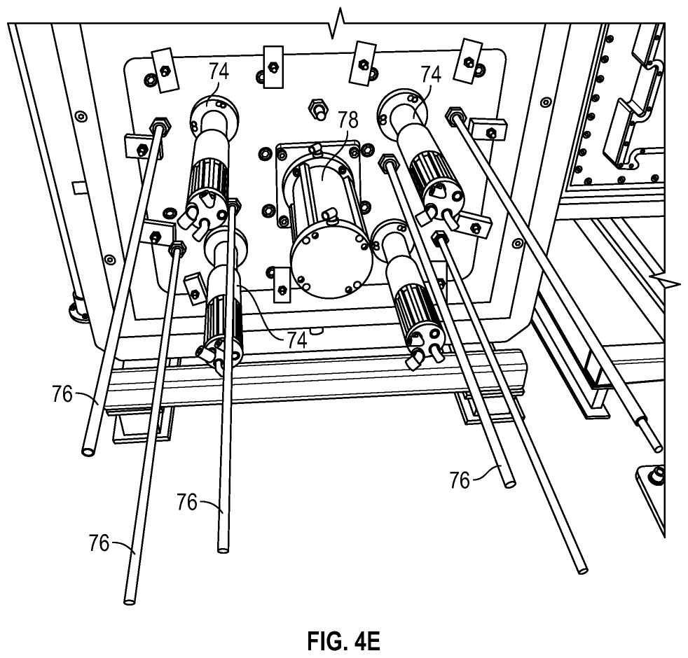

Referring now to FIGS. 4A-4E, there is illustrated a steam chest mold design for a thick section molded part. In general and for purposes of this disclosure, a thin section molded EPP or EPE component, such as an artificial turf shock pad, may be in a range of about 0.5 inches to about 6 inches. A thick section component may be in a range of 6 inches or greater. Any theoretical upper limit of component thickness is based, in part, on the size and spacing of the steam tubes. The temperature differential from inlet temperature to outlet temperature provides the limit of thermal energy available to heat and fuse the beads together during processing. In one embodiment related to shock pad formation, the thick section component may have a thickness in a range of about 6 inches to about 80 inches. In yet another embodiment, the thick section component thickness may be in a range of about 6 inches to about 24 inches and have hole diameter of about 0.5 inches and a lateral/longitudinal spacing in a range of about 5 inches to about 7 inches.

The above ranges for hole size and spacing for thin and thick section components also represents associated steam tube outer dimensions. The dimensional consideration referenced above are applicable for EPP or EPE finish-molded densities of about 0.0011 lb./cu. in. (30 gm/L) to about 0.0025 lb./cu. in. (70 gm/L). Lower density articles, such as panels having a formed density as low as 0.0007 lb./cu. in. (20 gm/L), such as for a shock pad application, may permit greater distance between steam tubes and/or smaller tube diameters to achieve bead expansion and bonding of bead to bead interfaces.

As shown in FIG. 4A, a male mold section, shown generally at 50, includes an outer profile 52 of alternating male and female dovetail joints, though singular dovetail connections or other surface profiles may be provided. The mold section 50 defines an inner mold face surface 54 have a plurality of vent ports 56 distributed over the surface. The vents 56 permit steam to be introduced into and be evacuated from the closed mold. The vents 56 are further configured to form raised structures on the part surface that increase friction to assist in retaining an artificial turf carpet in position. Referring now to FIGS. 4B-4D, a female mold section, shown generally at 60, includes a complementary perimeter or inner profile 62 that accepts and seals the outer profile 52 of the male mold section 50. The illustrated female mold section 60 defines a mold cavity 60a that is configured to form a thick-section billet. The mold section 60 includes a plurality of vents 64 distributed over a bottom surface 66 and side walls 68. The vents 64 function in the same manner as vents 56. A plurality of steam tubes 70 are positioned across the bottom surface 66 and are configured to be extended into and retracted from the cavity 60a as part of the molding process, though such is not required. The steam tubes 70 may be configured similarly to steam tubes 22, shown in FIG. 2, albeit sufficiently long to extend through the cavity 60a.

In one embodiment, the steam tubes 70 are configured as seamless tubing, though any tubular construction may be used, and is in fluid communication with a steam cavity behind the mold. In one embodiment, plurality of slots are cut into the tubes, e.g. with a laser, that will allow steam to be transmitted through the tube walls and into the center of the part being formed in the mold cavity 60a. Steam can still diffuse into the surface of the part through the steam vents 64 in the mold. In one embodiment, the slots may be in a range of about 0.001-0.062 inches wide and about 0.25 inches to about 1.5 inches long. Alternatively the pipes can be drilled with a plurality of small holes which may be configured in a range of about 0.001-0.062 inches in diameter. If the tubes are placed on 3″ to 4″ centers, the steam can effectively reach the interior of the part and allow for a thicker billet to be molded.

The billet mold can be designed with perimeter features 62 such as, for example, mating and interlocking configurations like male and female dovetail joints and spacing elements like crush ribs or edge projections. Using steam tubes 70 running through the component thickness (perpendicular to the face planar surfaces), the billet can be processed through cutting or parting equipment such as, for example, a slitter or hot wire knife to slice off multiple panels from a single billet. Each of the sliced panels for a turf shock pad configuration will have drainage holes extending through the thickness. FIG. 4C depicts the steam tubes 70 in an extended position ready for bead injection. The beads may be “blown” into the cavity 60a by inlet valves 72 associated with bead injectors 74 shown in FIG. 4E. At least one ejector pin 76 is extendable into and retractable from the cavity 60a to separate and eject the formed billet, as shown in FIG. 4D. The steam tubes 70 are connected together by a manifold, and the assembly of tubes is moved in and out of the cavity 60a by an actuator 78 as shown in FIG. 4 E.

In another embodiment, the steam tubes 70 are heated to cause the foam beads coming in contact with the pipes to partially melt and form a densified column of material in the proximity of the pipes. The steam tubes 70 may be heated as a function of the steam supply or may be heated by a separate heating element. After the molding process is complete, the densified material around the resulting holes provides enhanced compression strength so that when panels are sliced from the billet and used as a shock pad under artificial turf, the holes in the panels are not deformed during the cutting process and/or provide additional support around the opening to improve impact performance of the pad in the turf assembly.

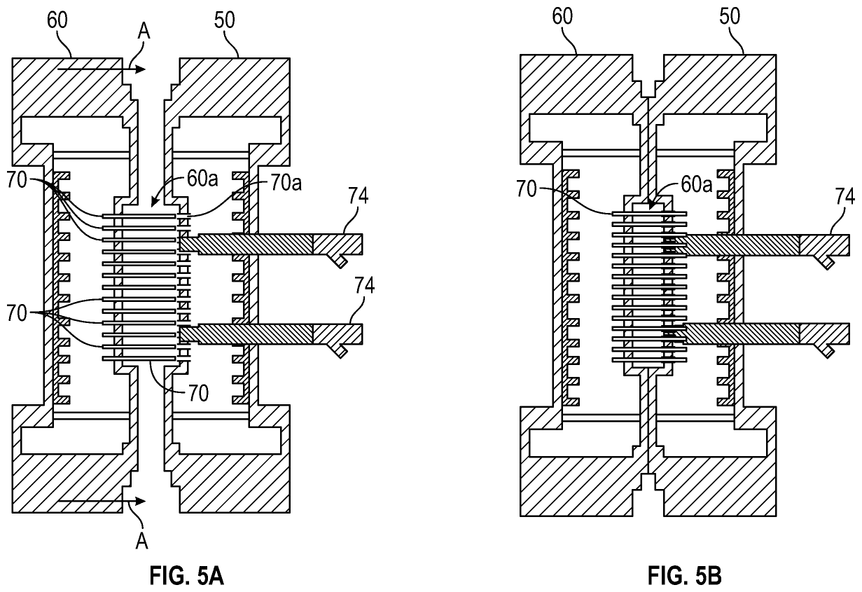

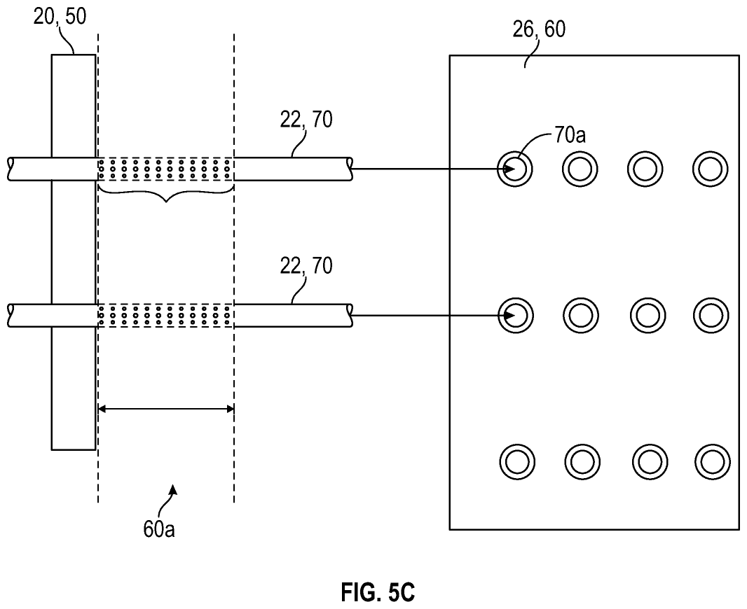

Referring now to FIGS. 5A-5C, there is illustrated a schematic illustration of first and second mold halves, similar to first and second mold halves 20 and 26 or male and female mold sections 50 and 60, in an open position. For simplicity, the elements and operation will be described in conjunction with the mold sections 50 and 60, though equally applicable to first and second mold halves 20 and 26. The steam tubes 70 are shown extending from the female mold section 60 into the cavity 60a. The bead injectors 74 are alternatively arranged on the opposite male mold section 50, as shown in the illustrated embodiment. In one embodiment, the steam tube 70 are moved into the closed cavity 60a after the mold sections 50 and 60 are brought together. In the illustrated embodiment, the steam tubes 70 extend into receiving ports 70a, as shown in FIGS. 5B and 5C. Alternatively, the steam tubes 70 are cantilevered from one of the mold sections and stop short of contacting the mating mold section. In this alternative configuration, receiving ports 70a may be omitted entirely. The two mold sections 50 and 60 are brought close but not completely together in the direction of arrows, A. The steam tubes 70 are extended into the cavity 60a, and the bead injectors 74 fill the slightly extended cavity 60a with the EPP or EPE beads. The mold halves 50, 60 are then brought into the final closed position which provides an initial, mechanical compression to the beads. As the steam passes through the steam tubes 70, the beads soften and expand in response to the heat. The contact points of the beads fuse creating an impervious billet structure. Water is sprayed to cool the billet. The steam tubes may be retracted at this stage, however such is not required. The mold halves are separated and the ejector pins push the billet from the cavity.

Below are example descriptions of actual test trials in conjunction with aspects of the thick-section embodiments described herein.

### Example I

A thick section billet was molded using steam pipes in a steam chest mold that was about 16 inches wide by about 24 inches long by about 11 inches thick. The steam pipes were about 0.5 inches in diameter and were spaced in a pattern whereby the pipes were between 5.0 and 7.0 inches apart. The steam pipes were actuated to extend through the mold cavity to within 0.25 inches of the opposite mold wall. Expanded polypropylene beads were pneumatically conveyed into the mold, the two mold halves were closed. Steam was applied to the mold cavity through steam vents in the walls of the mold and through the steam pipes, allowing steam to quickly permeate the interior of the cavity and fuse the beads together. Water was used to cool the mold. The mold was then opened, the steam pipes retracted, and ejector pins pushed the finished part from the female side of the mold. Successive parts were molded, with two receiving 24 hours of aging time in an oven at about 140 degrees F., and two receiving 24 hours of aging in ambient air. The length and width measurements for the four billets is shown in the table below:

| | Cure | Avg. | Length | Avg. | Width |
|---|---|---|---|---|---|
| Billet | Condition | Length | stdev | Width | stdev |
| A | Oven | 408.9 | 2.2 | 618 | 2.3 |
| B | Oven | 405.2 | 0.9 | 612.3 | 0.5 |
| C | Air | 409.1 | 1.4 | 618.3 | 1.4 |
| D | Air | 409.1 | 1.2 | 617.7 | 1.2 |

### Example II

Two billets of EPP were molded using the same process conditions as EXAMPLE I except the steam pipes were not extended into the mold cavity to assist in fusing the interior beads. Upon completion of the molding cycle the billets were cut open and beads were easily separated from the middle of the billet (i.e. the interior beads were not fused together). Additional billets were molded with a longer steam time, but failed to achieve adequate interior bead fusion.

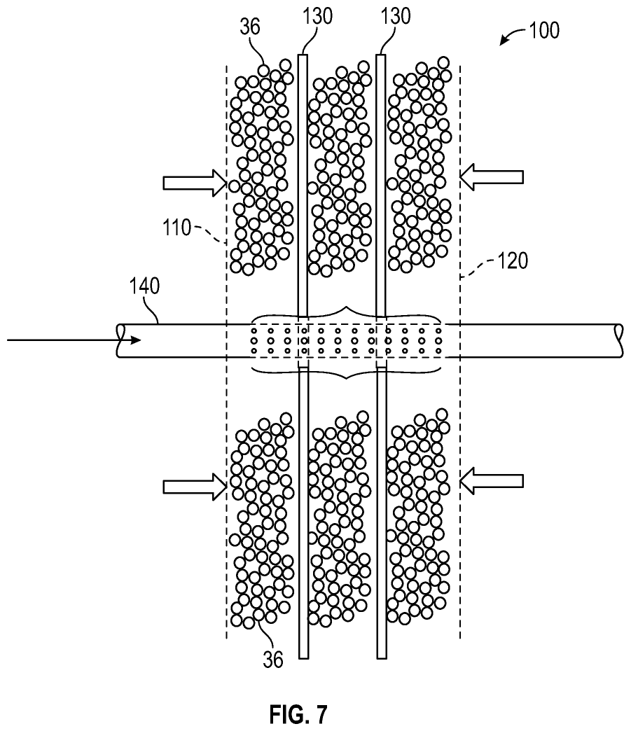

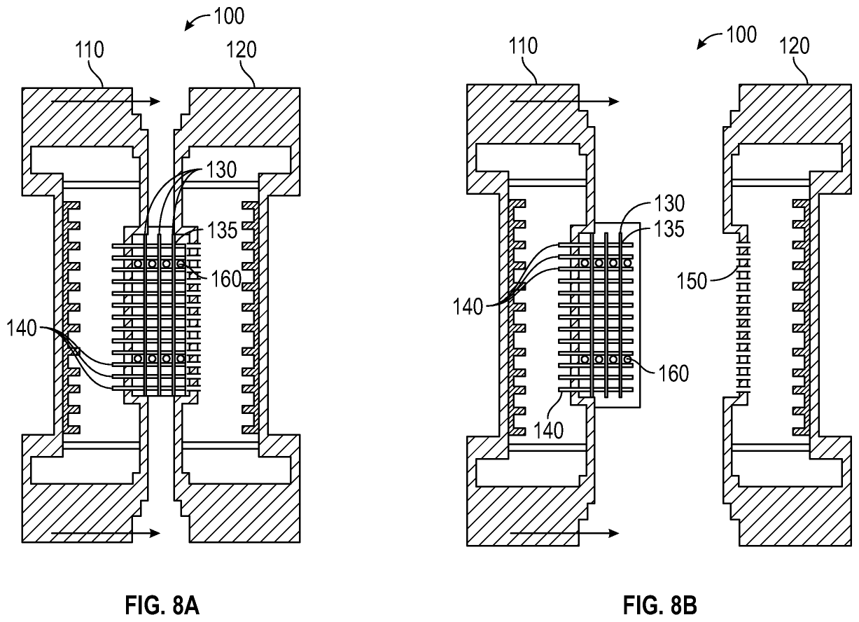

Referring now to FIGS. 7 and 8A-B, an alternative embodiment of the internally steam vented mold configuration is illustrated to produce net formed panel sections having topographical features formed on each side of the molded panels. Mold sections 110 and 120 are similar to mold sections 50 and 60 in that the closed cavity is configured to form a thick-section billet. The mold sections 100 and 120 include the attributes of mold sections 20 and 26 having the topographical surface features associated with surfaces 30 and 32. Intermediate mold form partitions or curtains 130 are placed within the mold cavity to form individual panel cavities. Each curtain 130 has the desired topographical features, such as those of surfaces 30 and 32 formed on the facing surfaces. When arranged together, the curtains and the mold sections are capable of producing a plurality of molded panel structures with topographical elements in a single mold shot. Steam tubes 140 pass through apertures 135 formed in the curtains 130 and may extend into corresponding steam tube receivers 150 in the mating mold section. The processing of the planks or finished shock pads is similar to the steps described in conjunction with the molding embodiments above. The beads are injected into the mold cavity through the side or thickness face of the mold. As shown in FIGS. 8A and 8B, the bead injectors 160 are provided between each curtain. Alternatively, a bead distribution manifold may be provided having exit ports positioned at the bead injector sites 160, Once the beads are blown into the mold between the curtains, the mold is further closed together to slightly compress the beads and space the curtains 130 apart to the desired thickness. The curtains 130 may include spacers to maintain the final panel thicknesses. The process is performed in the same manner as described above with the steam tubes passing through each of the curtains such that steam is conducted through the entire mold cavity and into each panel cavity. The mold and/or each of the curtains may be water cooled and separated to form several finished panels in a single mold shot.

The principle and mode of operation of this invention have been explained and illustrated in its preferred embodiment. However, it must be understood that this invention may be practiced otherwise than as specifically explained and illustrated without departing from its spirit or scope.

1. A mold for forming a billet of expanded polyolefin beads, the mold comprising:
a first mold section supporting at least one steam tube, the at least one steam tube having a plurality of steam ports formed therein, the plurality of steam ports forming a bead heating section;
a second mold section cooperating with the first mold section to form a closed billet cavity around the bead heating section; and
a bead injector configured to fill the billet cavity with expandable polyolefin beads such that the bead heating section passes steam through the expandable polyolefin beads and forms the billet.

2. The mold of claim 1 wherein at least one of the first mold section or the second mold section defines a topographical surface that is formed onto at least one surface of the billet.

3. The mold of claim 1 wherein one of the first mold section or the second mold section define a billet perimeter profile having at least one of a male or a female dovetail joint section.

4. The mold of claim 1 wherein the second mold section includes at least one steam tube aperture that engages the at least one steam tube when the first and second mold sections are closed together.

5. The mold of claim 1 wherein the billet defines a thin-section panel having a thickness in a range of about 0.5 inch to about 6 inches.

6. The mold of claim 5 wherein the at least one steam tube is a plurality of steam tubes and the thin-section panel includes a plurality of holes formed by the plurality of steam tubes, the plurality of holes being spaced apart in a range of about 1.75 inches to about 3.0 inches.

7. The mold of claim 6 wherein the plurality of steam ports are configured as holes having a diameter in a range of about 0.001 inch-0.062 inch and the plurality of holes each have a diameter of about 0.25 inches.

8. The mold of claim 1 wherein the billet defines a thick-section panel having a thickness in a range of about 6.5 inches to about 80 inches.

9. The mold of claim 8 wherein the at least one steam tube is a plurality of steam tubes and the thick-section panel includes a plurality of holes formed by the plurality of steam tubes, the plurality of holes being spaced apart in a range of about 4 inches to about 8 inches.

10. The mold of claim 9 wherein the plurality of steam ports are configured as holes having a diameter in a range of about 0.001 inch-0.062 inch and the plurality of holes each have a diameter in a range of about 0.4 inch to about 0.8 inch.

11. The mold of claim 1 wherein the steam ports are configured as a plurality of slots in a range of about 0.001 inch to about 0.062 inch wide and in a range of about 0.25 inch to about 1.5 inches in length.

12. The mold of claim 11 wherein the steam tubes are positioned in a relative spacing of about 3 inches to about 4 inches apart.

13. The mold of claim 1 wherein at least one curtain is disposed in the closed billet cavity between the first and second mold sections, the at least one curtain having an aperture that permits the steam tube to pass through the curtain.

14. The mold of claim 13 wherein at least one of the first mold section or the second mold section and one side of the curtain each define a topographical surface that is formed onto at least one surface of the billet.

15. The mold of claim 1 wherein one of the first mold section or the second mold section includes at least one ejector pin configured to separate the billet from the mold.

16. A method of forming a billet of expanded polyolefin beads, the method comprising the steps of:
providing a first mold section and a second mold section;
closing the first and second mold sections to define a billet cavity;
extending at least one steam tube into the billet cavity and positioning a bead heating section within the billet cavity;
injecting a plurality of polyolefin beads into the billet cavity and around the bead heating section;
passing steam through the at least one steam tube and exiting the steam through the bead heating section into the plurality of beads to form the billet.
